(19) United States
(12) Patent Application Publication
(10) Pub. No.: US 2024/0123634 A1
(43) Pub. Date: Apr. 18, 2024

(54) GRIPPER, CLAMPING DEVICE HAVING THE SAME AND MOBILE ROBOT

(71) Applicant: SHENZHEN JINGTAI TECHNOLOGY CO., LTD., Shenzhen (CN)

(72) Inventors: Yongkang WANG, Shenzhen (CN); Jiandong GAO, Shenzhen (CN); Jian ZHANG, Shenzhen (CN); Zhiheng HE, Shenzhen (CN)

(21) Appl. No.: 18/394,831

(22) Filed: Dec. 22, 2023

Related U.S. Application Data
(63) Continuation of application No. PCT/CN2023/101652, filed on Jun. 21, 2023.

(30) Foreign Application Priority Data
Jun. 22, 2022 (CN) 202210711412.0

(51) Int. Cl. B25J 15/12

(52) U.S. Cl. CPC B25J 15/12

(57) ABSTRACT

The present disclosure relates to a gripper, a clamping device having the same and a mobile robot. The gripper includes a gripper arm which is configured to be connected with a driving mechanism of the clamping device, and a gripper finger which is floatably connected to the gripper arm. The gripper finger has a clamping surface. The gripper arm is driven by the driving mechanism to move so as to drive the gripper finger to clamp or release an object to be clamped. Some solutions provided in the present disclosure can solve the problem that the tray cannot be clamped up or is easy to slip off.

### CROSS-REFERENCE TO RELATED APPLICATIONS

The present disclosure claims priority to Chinese Patent Application No. 202210711412.0, filed with the China National Intellectual Property Administration on Jun. 22, 2022, entitled “GRIPPER, CLAMPING DEVICE HAVING THE SAME AND MOBILE ROBOT”, the contents of which are all incorporated herein by reference in its entirety.

### TECHNICAL FIELD

The present disclosure relates to the technical field of automation equipment, in particular to a gripper, a clamping device having the same and a mobile robot.

### BACKGROUND

When conducting automatic experiments, a lot of standard trays need to be carried, grippers capable of stably clamping various trays are therefore needed. However, existing grippers are prone to causing the tray to slip off when clamping it. In addition, when the grippers are slightly unparallel to the tray, it is easy to encounter the problem of clamping failure, which poses a risk of the tray not being able to be clamped up or falling off during the process.

### SUMMARY

The present disclosure provides a gripper, a clamping device having the same and a mobile robot, which aim to solve the problem that the tray cannot be clamped up or is easy to slip off.

In a first aspect, the present disclosure provides a gripper including a gripper arm which is configured to be connected with a driving mechanism of the clamping device, and a gripper finger which is floatably connected to the gripper arm, the gripper finger having a clamping surface, the gripper arm being driven by the driving mechanism to move so as to drive the gripper finger to clamp or release an object to be clamped.

In an embodiment, the gripper further includes an elastic pad arranged on the clamping surface of the gripper finger and used to be elastically abutted against the object to be clamped when the gripper finger clamps the object to be clamped.

In an embodiment, a surface of the elastic pad which is used to be engaged with the object to be clamped is provided with an anti-slip part, and the elastic pad is a foamed silicone pad.

In an embodiment, the gripper finger includes a first connecting part which is rotatably and floatably connected to the gripper arm, and a second connecting part which is connected with the first connecting part, the clamping surface being at a surface of the second connecting part away from the gripper arm.

In an embodiment, the gripper further includes an elastic member which is arranged between the gripper arm and the gripper finger, one end of the elastic member being connected with the gripper arm, and the other end of the elastic member being abutted against the gripper finger.

In an embodiment, the gripper includes at least two said elastic members which are uniformly distributed on the gripper arm, and the elastic member is a spring.

In an embodiment, the first connecting part is connected to the gripper arm by a step screw so that the first connecting part is rotatable relative to the gripper arm with the step screw as a rotating fulcrum.

In an embodiment, the gripper further includes a lubricating gasket arranged between the gripper arm and the gripper finger.

In an embodiment, the step screw is arranged at a middle position of the first connecting part, and the lubricating gasket is fixed between the gripper arm and the first connecting part by the step screw.

In an embodiment, a maximum angle range of the rotation of the first connecting part relative to the gripper arm is 1 to 2 degrees, and the first connecting part is perpendicular to the second connecting part.

In an embodiment, the gripper arm includes a third connecting part and a fourth connecting part, a first end of the third connecting part being used to be connected with the driving mechanism, a first end of the fourth connecting part being connected with a second end of the third connecting part, a second end of the fourth connecting part being a free end, and the gripper finger being connected to the fourth connecting part.

In an embodiment, the second end of the fourth connecting part is flush with a forwardmost end of the gripper finger, or the second end of the fourth connecting part extends beyond a foremost end of the gripper finger.

By floatably connecting the gripper finger to the gripper arm, when the clamping surface of the gripper finger is slightly unparallel to the tray, the gripper finger can adjust the clamping direction to successfully clamp the tray, thus the tray will not fall off during clamping and transportation.

In a second aspect, the present disclosure provides a clamping device which includes a driving mechanism, and two grippers which can be any one of the grippers described above, the gripper arms of the two grippers being connected with the driving mechanism respectively, the clamping surfaces of the gripper fingers of the two grippers being arranged opposite each other, and the two gripper fingers being driven by the driving mechanism to move close to or away from each other.

In an embodiment, the driving mechanism is provided with two connecting members being slidable relative to each other, the two gripper arms are connected with the two connecting members respectively, and a relative sliding direction of the two connecting members is the same as a relative moving direction of the two gripper fingers.

In an embodiment, the clamping device further includes a quick-change connector which is connected with the driving mechanism and used for a quick change of a connection between the driving mechanism and a peripheral device.

In an embodiment, the connection between the connecting member and the gripper arm is a rotatable connection, and the gripper finger extends in a direction perpendicular to or parallel to an orientation of the driving mechanism.

In a third aspect, the present disclosure provides a mobile robot including a moving mechanism and any one of clamping devices described above, wherein the moving mechanism is connected with the clamping device and is capable of driving the clamping device to move.

Due to the gripper having the above effects, the clamping device having the gripper and the mobile robot also have corresponding technical effects.

It should be understood that the foregoing general description and the following detailed description are illustrative and explanatory only and do not limit the present disclosure.

### BRIEF DESCRIPTION OF THE DRAWINGS

By providing a more detailed description of the exemplary embodiments of the present disclosure in combination with the accompanying drawings, the foregoing and other objects, features, and advantages of the present disclosure will be apparent. In the exemplary embodiments of the present disclosure, the same reference numerals generally represent the same components.

FIG. 1 is a view of a gripper according to an embodiment of the present disclosure;

FIG. 2 is a three-dimensional view of a clamping device according to an embodiment of the present disclosure;

FIG. 3 is a front view of the clamping device according to an embodiment of the present disclosure;

FIG. 4 is a left-side view of the clamping device according to an embodiment of the present disclosure;

FIG. 5 is a right-side view of the clamping device according to an embodiment of the present disclosure;

FIG. 6 is a plan view of the clamping device according to an embodiment of the present disclosure;

FIG. 7 is a bottom view of the clamping device according to an embodiment of the present disclosure;

FIG. 8 is a partial view of the clamping device according to an embodiment of the present disclosure;

FIG. 9 is a three-dimensional view of a clamping device according to another embodiment of the present disclosure.

### DETAILED DESCRIPTION OF THE EMBODIMENTS

Some embodiments of the present disclosure will be described in more detail below with reference to the accompanying drawings. Although some embodiments of the present disclosure are shown in the accompanying drawings, it should be understood that the present disclosure can be implemented in various forms and should not be limited by the embodiments described here. On the contrary, these embodiments are provided to make the present disclosure more thorough and complete, and to fully convey the scope of the present disclosure to ones skilled in the art.

The terms used in the present disclosure are for the purpose of describing specific embodiments only and are not intended to be limit of the present disclosure. The singular forms “a”, “said”, and “the” used in the present disclosure and the accompanying claims are intended to include the plural forms as well, unless the context clearly indicates other meanings. It should also be understood that the term “and/or” used herein refers to and includes any or all possible combinations of one or more related listed items.

It should be understandable that although the terms “first,” “second,” “third,” etc. may be used herein to describe various information, the information should not be limited to these terms. These terms are only used to distinguish the same type of information from each other. For example, without departing from the scope of the present disclosure, first information may also be referred to as second information, and similarly, second information can also be referred to as first information. Thus, a feature defined as “first” or “second” may explicitly or implicitly include one or more of that feature. In the description of the present disclosure, “a plurality of” means two or more unless specifically limited otherwise.

The present disclosure provides a gripper, a clamping device having the same and a mobile robot, which can solve the problem that the tray cannot be clamped up or is easy to slip off.

Technical solutions of some embodiments of the present disclosure will be described in detailed with reference to the accompanying drawings.

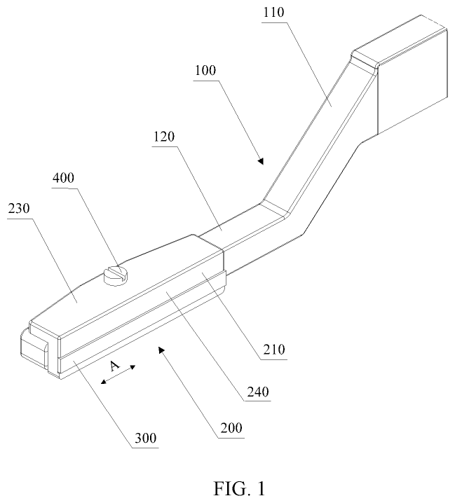

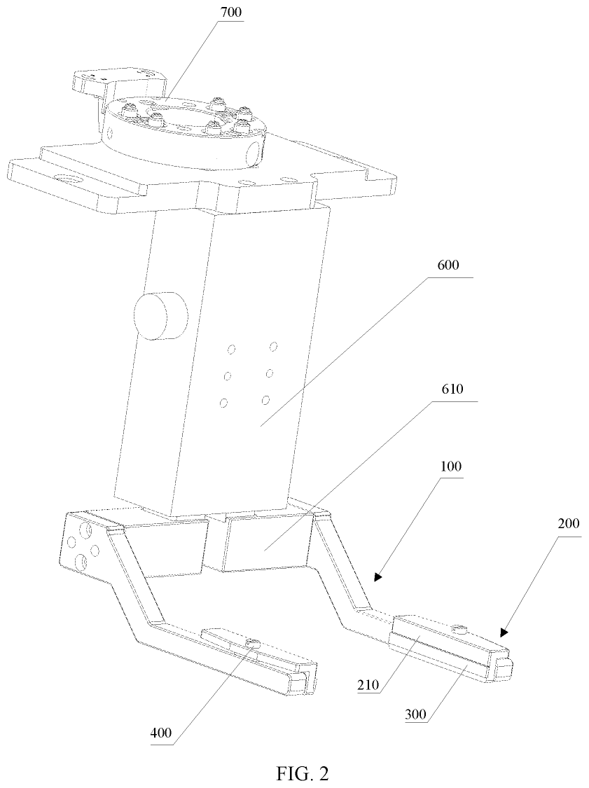

Referring to FIGS. 1 and 2, a gripper according to an embodiment of the present disclosure includes a gripper arm 100 and a gripper finger 200. The gripper arm 100 is used to be connected with a driving mechanism 600 of a clamping device. The clamping device can be used to clamp a tray, a rack or the like. The tray can be a tray for test tubes or a tray for Tip heads for example. In a specific implementation, the gripper arm 100 may be in an elongated structure, and the cross-section of the gripper arm may be rectangular, square, polygonal or the like. The first end of the gripper arm 100, which can be the upper end of the gripper arm 100 in FIG. 1, is connected with the driving mechanism 600.

The gripper finger 200 is connected to the gripper arm 100. The gripper finger 200 has a clamping surface 210. The region corresponding to the clamping surface 210 is the clamping region. The driving mechanism 600 can drive the gripper arm 100 to move in a direction close to or away from the clamping region. In a specific implementation, the gripper finger 200 is connected to the second end of the gripper arm 100 which can be the lower end of the gripper arm 100 in FIG. 1. The moving direction of the gripper arm 100 may be perpendicular to or may be at an angle with the clamping surface 200.

Continued with FIG. 1, in some embodiments, the gripper arm 100 includes a third connecting part 110 and a fourth connecting part 120. The first end of the third connecting part 110, which can be the rear end of the third connecting part 110 in FIG. 1, is used to be connected with the driving mechanism 600. The second end of the third connecting part 110, which can be the front end of the third connecting part in FIG. 1, is connected with the first end of the fourth connecting part 120 which can be the rear end of the fourth connecting part 110 in FIG. 1. The second end of the fourth connecting part 120, which can be the front end of the fourth connecting part 110 in FIG. 1, is a free end. The gripper finger 200 is connected to the fourth connecting part 120. In a specific implementation, the third connecting part 110 and the fourth connecting part 120 are integrally formed.

In some embodiments, the second end of the fourth connecting part 120 is flush with the forwardmost end of the gripper finger 200, or the second end of the fourth connecting part 120 extends beyond the forwardmost end of the gripper finger 200, namely, is slightly longer than the forwardmost end of the gripper finger 200, so as to ensure stability of the floatable gripper finger 200. Specifically, the forwardmost end of the gripper finger 200 can be the end of the gripper finger 200 away from the third connecting part 110.

It should be understandable that the third connecting part 110 and the fourth connecting part 120 may be connected at an angle as shown in FIG. 2, or may be in a straight line, which is not limited herein.

In the present embodiment, the gripper finger 200 is floatably connected to the gripper arm 100 such that the clamping surface 210 of the gripper finger 200 is floatable relative to the gripper arm 100.

In the related art, the clamping surface of the gripper finger 200 is fixed relative to the gripper arm 100. When the gripper finger 200 clamps a tray, if the clamping surface 210 is slightly unparallel to the tray, the clamping may be easily failed. Even if the clamping is successful, during the transportation of the tray, the fact that the clamping surface 210 of the clamping finger 200 is unparallel to the tray may easily cause untight clamping, leading to falling off of the tray.

In the present embodiment, by floatably connecting the gripper finger 200 to the gripper arm 100, when the clamping surface 210 of the gripper finger 200 is slightly unparallel to the tray, the gripper finger 200 can adjust the clamping direction to successfully clamp the tray, thus the tray will not fall off during clamping and transportation.

In some embodiments, the gripper further includes an elastic pad 300 which is arranged on the clamping surface 210 of the gripper finger 200 and is used to be elastically abutted against the object to be clamped when the gripper finger 200 clamps the object to be clamped. The elastic pad 300 may be a foamed silicone pad, a rubber pad or the like.

In this embodiment, the thickness of the foamed silicone pad is 1 mm. Of course, in some other embodiments, the foamed silicone pad may be of other thicknesses, such as 2 mm. The present embodiment does not limit the specific thickness of the foamed silicone pad.

In an embodiment, the elastic pad 300 is adhered to the clamping surface 210, for example by 3M glue. In another embodiment, the gripper finger 200 is formed with a receiving slot, such as a dovetail slot, and the elastic pad 300 is partially embedded into the dovetail slot.

Referring to FIG. 2, it should be understandable that two grippers of the present embodiment may be used in cooperation with each other. The region between the clamping surfaces 210 of the two gripper fingers 200 is the clamping region. The two grippers may be close to or far away from each other. When an object to be clamped, such as a tray, is placed in the clamping region, the driving mechanism 600 drives the gripper arms 100 to move towards the clamping region, and the clamping surfaces 210 of the two gripper fingers 200 are close to each other meantime so as to make the elastic pad 300 engaged with the object to be clamped and apply a clamping pressure to the object to be clamped, thereby clamping the object to be clamped. When the driving mechanism 600 drives the gripper arms 100 to move away from the clamping region, the clamping surfaces 210 of the two gripper fingers 200 move away from each other, and the elastic pad 300 is separated from the object to be clamped so as to release the object to be clamped.

In the present embodiment, the elastic pad 300 is arranged on the gripper finger 200. Compared with the related art, under the same clamping pressure, the friction force between the elastic pad 300 and the object to be clamped in the present embodiment is greatly increased, and the risk of sliding down of the object to be clamped, such as a tray, is effectively prevented. In addition, as the elastic pad 300 is soft, the tray is not worn when being clamped and the hard contact with the tray is avoided.

In some embodiments, the surface of the elastic pad 300 which is used to be engaged with the object to be clamped is provided with an anti-slip part in a protruding manner so as to further increase the friction between the elastic pad 300 and the object to be clamped. In a specific implementation, the elastic pad 300 is a foamed silicone pad, and the anti-slip part is a striped structure, such as a linear stripe, a wavy stripe or the like, which protrudes from the surface of the elastic pad 300. Alternatively, the anti-slip part may be in the form of dots, circles, ellipses, and irregular shapes.

In an embodiment, the gripper finger 200 is sheet-shaped, and the gripper finger 200 is connected to the gripper arm 100 by a step screw 400.

Referring to FIG. 1, in another embodiment, the gripper finger 200 includes a first connecting part 230 and a second connecting part 240. The first connecting part 230 and the second connecting part 240 are both sheet-shaped and connected with each other to form a bent structure. The first connecting part 230 is rotatably and floatably connected to the gripper arm 100. The second connecting part 240 is connected with the first connecting part 230. The region corresponding to the second connecting part 240 is the clamping region. The clamping surface 210 is at a surface of the second connecting part 240 away from the gripper arm 100. Specifically, the first connecting part 230 and the second connecting part 240 are integrally formed.

In a specific implementation, the first connecting part 230 is connected to the gripper arm 100 by a step screw 400. The first connecting part 230 may be perpendicular to the second connecting part 240. The maximum angle range of the rotation of the gripper finger 200 relative to the gripper arm 100 is 1 to 2 degrees. Specifically, the maximum angle range of the rotation of the first connecting part 230 relative to the gripper arm 100 is 1 to 2 degrees. Of course, it may be determined as other angles according to the actual situation and the present embodiment does not pose any limitations on it.

It should be noted that in the present embodiment, the first connecting part 230 is rotatable relative to the gripper arm 100 with the step screw 400 as a rotation center, and is also floatable in the direction close to or away from the gripper arm 100 with the step screw 400 as a fulcrum.

When the first connecting part 230 rotates along the step screw 400 relative to the gripper arm 100, the first connecting part 230 drives the second connecting part 240 to swing so as to adjust the parallelism between the clamping surface 210 and the tray in the direction A as shown in FIG. 1.

It can be seen that in the present embodiment the connection between the gripper fingers 200 and the gripper arms 100 is a rotatable floating connection. When the gripper finger 200 is slightly unparallel to the tray, the gripper finger 200 can automatically adjust its position to keep parallel to the tray, thereby effectively preventing the risk of the tray not being able to be clamped up or falling off during the process.

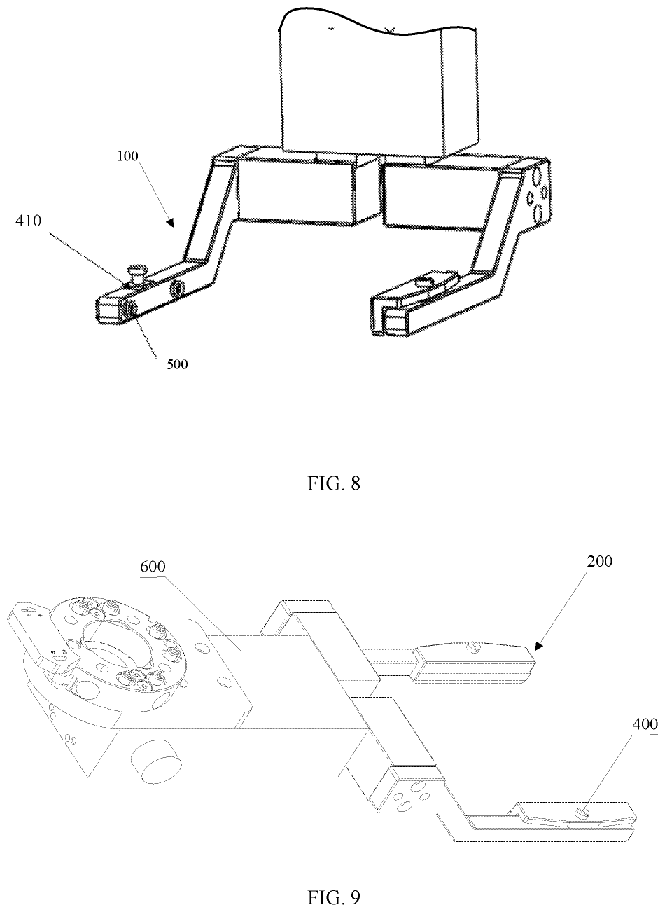

FIG. 8 is a partial view of the clamping device according to an embodiment of the present disclosure, with the gripper finger 200 on the left gripper arm 100 being removed.

Continued with FIG. 8, in some embodiments, the gripper further includes an elastic member 500 which is arranged between the gripper arm 100 and the gripper finger 200 and corresponding to the clamping surface 210. One end of the elastic member 500 is connected with the gripper arm 100, and the other end is a free end. The free end is abutted against the second connecting part of the gripper finger 200. In a specific implementation, the elastic member 500 may be a spring, an elastic sheet, an elastic column, a rubber block, or the like, and the number of the elastic members 500 is at least two. The at least two elastic members 500 are uniformly arranged in the direction A as shown in FIG. 1.

In an implementation, the number of the elastic members 500 is two, and the two elastic members 500 are symmetrically arranged with the center of the second connecting part 240 or the clamping surface 210 as the symmetrical center.

In another implementation, the number of the elastic members 500 is three. One of the three elastic members 500 is located at the center of the second connecting part 240 or the gripping surface 210 and the other two are symmetrically arranged with the center as the symmetrical center. Or two of the three elastic members 500 are located at the same side of the center, and the other is located at the other side of the center.

In yet another implementation, the number of the elastic members is four. The four elastic members are evenly distributed along the length direction of the second connecting part 240 or the clamping surface 210. Or the four elastic members 500 are arranged as two pairs which are symmetrically arranged with the center of the second connecting part 240 or the clamping surface 210 as the symmetrical center.

Referring to FIG. 2, it should be understandable that two grippers in the present embodiment are needed to cooperate with each other. The elastic members 500 provided in the present embodiment mainly function as elastic supports to keep the clamping surfaces 210 of the two gripper fingers 200 in parallel when clamping or not clamping the tray.

In some embodiments, the first connecting part 230 is connected to the gripper arm 100 by a step screw 400 so that the first connecting part 230 is rotatable relative to the gripper arm 100 with the step screw as a rotating fulcrum.

In some embodiments, a lubricating gasket 410 is further included. The lubricating gasket 410 is arranged between the gripper arm 100 and the gripper finger 200, and more specifically between the gripper arm 100 and the first connecting part 230 of the gripper finger 200. Specifically, the lubricating gasket 410 may be a metal gasket, such as a brass gasket, or a non-metal gasket such as a PPS gasket. The step screw 400 is arranged at a middle position of the first connecting part 230. The lubricating gasket 410 is fixed between the gripper arm 100 and the first connecting part 230 by the step screw 400.

In the present embodiment, the lubrication gasket 410 can be self-lubricated when the gripper finger 200 rotates, thereby keeping the smooth of the rotation of the gripper finger 200.

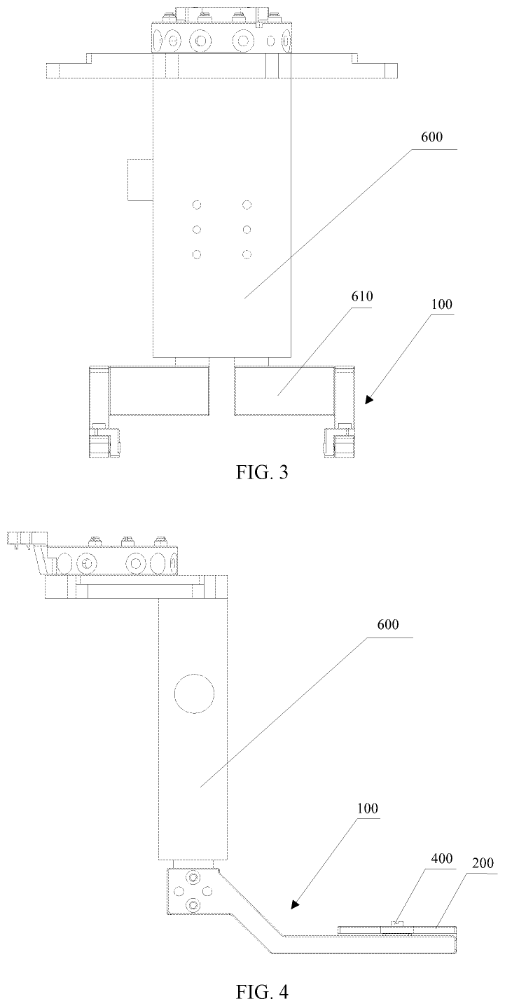

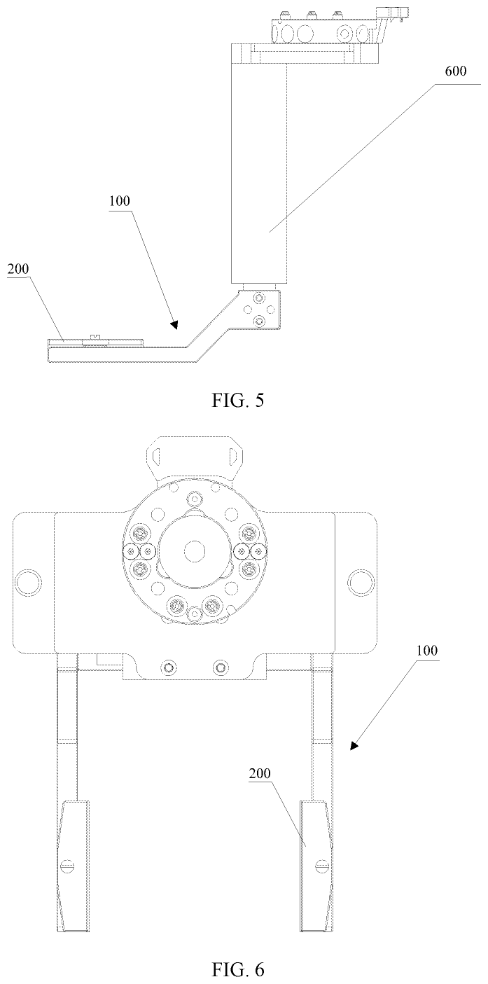

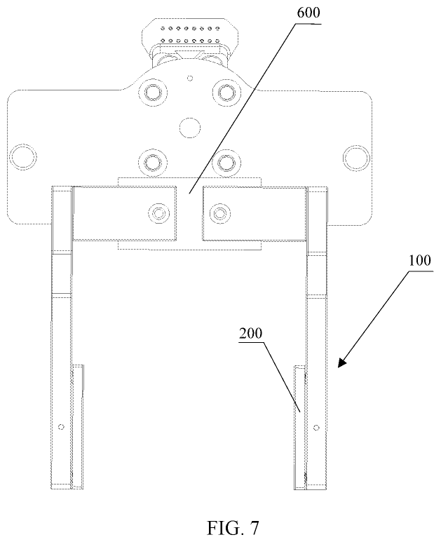

Referring to FIGS. 2 to 9, another embodiment of the present disclosure provides a clamping device which includes a driving mechanism 600 and two grippers which can be any one of the grippers described above. The gripper arms 100 of the two grippers are connected with the driving mechanism 600 respectively. The clamping surfaces 210 of the gripper fingers 200 of the two grippers are arranged opposite each other. The two gripper fingers 200 are driven by the driving mechanism 600 to move close to or away from each other. The region between the two clamping surfaces 210 is the clamping region. The driving mechanism 600 controls the gripper arms 100 to open or close. That is, the gripper arms move towards the clamping region when closing and move away from the clamping region when opening. The driving mechanism 600 is a power source for the movement of the gripper arms 100.

Due to the fact that the gripper has the foregoing effect, the clamping device having the grippers also has the corresponding technical effect.

In some embodiment, the driving mechanism 600 includes at least one driving member for driving the two grippers to move. The driving member may be a motor, a cylinder or the like. In some embodiments, the driving mechanism 600 includes a driving element for driving the two grippers to move. In some other embodiments, the driving mechanism 600 includes two driving members for respectively driving the two grippers to move.

In some embodiments, the driving mechanism 600 is provided with two connecting parts and two connecting members 610 which are slidable relative to each other. The two connecting parts are connected with the two connecting members 610 respectively. The two gripper arms 100 are connected with the two connecting members 610 respectively. The relative sliding direction of the two connecting members 610 is the same as the relative moving direction of the two jaw fingers 200.

In the present embodiment, the connecting member 610 of the driving mechanism 600 is provided with a slider such as a sliding block or a pulley, and the connecting part of the driving mechanism is provided with a guide rail which is in cooperation with the slider to form a sliding connection. The slider can slide along the guide rail. Alternatively, the connecting member 610 of the driving mechanism 600 is provided with a sliding rail, and the connecting part of the driving mechanism is provided with a guiding member, such as a guiding block, which is in cooperation with the sliding rail to form a sliding connection. The sliding rail can slide along the guiding member.

It should be understandable that the driving mechanism 600 is provided with a control mechanism. The connecting members 610 are controlled by the control mechanism to slide relative to the connecting parts of the driving mechanism 600. That is, the control mechanism can control the two connecting members 610 to slide relative to each other, and the two connecting members 610 drive the gripper arms 100 and therefore drive the gripper fingers 200 to move relative to each other so as to clamp the object to be clamped between the two clamping surfaces 210.

Referring to FIG. 2, in some embodiments, the clamping device further includes a quick-change connector 700 which is connected with the driving mechanism 600 and is used for a quick change of the connection between the driving mechanism 600 and a peripheral device. In a specific implementation, the quick-change connector 700 is a quick-change female connector. One end of the quick-change female connector can be connected to the driving mechanism 600 through a quick-change connecting plate, and the other end of the quick-change female connector can be automatically connected to or disconnected from a quick-change male connector on the peripheral device. Specifically, the peripheral device may be a mobile device, such as a robotic arm.

In some embodiments, the quick-change female connector and the driving mechanism 600 are connected through a quick-change connector as well so as to facilitate quick connection or disconnection of the driving mechanism 600.

Referring to FIGS. 2 to 9, the connection between the connecting member 610 and the gripper arm 100 is a rotatable connection. The gripper finger 200 extends in the direction perpendicular to or parallel to the orientation of the driving mechanism 600.

Referring to FIGS. 2 to 8, in some embodiments, the gripper finger 200 extends in the direction perpendicular to the orientation of the driving mechanism 600. It can be seen that, in the present embodiment, the driving mechanisms 600 are arranged in the vertical direction and the gripper arms 100 are arranged in the horizontal direction.

Referring to FIG. 9, in some other embodiments, the gripper fingers 200 extend in the direction parallel to the orientation of the driving mechanism 600. It can be seen that, in this embodiment, the driving mechanisms 600 and the gripper arms 100 are all arranged in the horizontal direction. The arrangement direction can be correspondingly selected according to the size of the space where the object to be clamped is. For example, a clamping device with the driving mechanisms being perpendicular to the gripper fingers can be adopted when the space is large, and a clamping device with the driving mechanisms and the gripper fingers horizontally arranged can be adopted when the space is small.

In some embodiments of the present disclosure, when a tray needs to be clamped, the clamping device is moved to the position of the tray and the gripper fingers 200 at two sides are driven by the driving mechanism to move towards the middle. Because the elastic pad 300 is attached at the contact position of the gripper finger 200 with the tray, the friction force is greatly improved under the same clamping pressure, and the risk of sliding down of the tray is effectively prevented. In addition, the gripper fingers 200 are floatably connected with the gripper arms 100. When the gripper finger 200 is slightly unparallel to the tray, the gripper finger 200 can automatically adjust its position to keep the clamping surface 210 of the gripper finger 200 being parallel to the tray, thereby effectively preventing the risk of the tray not being able to be clamped up or falling off during the process. When the clamping force reaches a set value, the gripper fingers 200 maintain the clamping force and remain self-locking after power is off, thus the tray will not fall off even if the power is suddenly turned off during the clamping process. According to different usage circumferences, the clamping device can be horizontally assembled, as shown in FIG. 9, or be assembled perpendicularly, as shown in FIG. 2.

The present disclosure further provides a mobile robot which includes the moving mechanism and any one of the clamping devices described above. The moving mechanism is connected with the clamping device and is capable of driving the clamping device to move. Specifically, the moving mechanism can be a robotic arm, such as a six-axis robotic arm, and the robotic arm is connected with the clamping device through a quick-change connector, which can meet the requirements of automated experiments.

Various embodiments of the present disclosure have been described above. The above description is exemplary but not exhaustive, and the present disclosure is not limited to the disclosed embodiments. Without deviating from the scope and spirit of the various embodiments illustrated, many modifications and changes are obvious to a person skilled in the art. The selection of terms used in this text aims to best explain the principles, the practical applications of various embodiments, or the improvements to the technologies in the market, or to enable other ordinary technical persons in the art to understand the disclosed embodiments.

What is claimed is:

1. A gripper which is applied to a clamping device, comprising:
a gripper arm which used to be connected with a driving mechanism of the clamping device; and
a gripper finger which is floatably connected to the gripper arm, the gripper finger having a clamping surface, the gripper arm being driven by the driving mechanism to move so as to drive the gripper finger to clamp or release an object to be clamped.

2. The gripper according to claim 1, further comprising:
an elastic pad arranged on the clamping surface of the gripper finger and used to be elastically abutted against the object to be clamped when the gripper finger clamps the object to be clamped.

3. The gripper according to claim 2, wherein:
a surface of the elastic pad which is used to be engaged with the object to be clamped is provided with an anti-slip part; and
the elastic pad is a foamed silicone pad.

4. The gripper according to claim 1, wherein the gripper finger comprises:
a first connecting part which is rotatably and floatably connected to the gripper arm; and
a second connecting part which is connected with the first connecting part, the clamping surface being at a surface of the second connecting part away from the gripper arm.

5. The gripper according to claim 1, further comprising:
an elastic member which is arranged between the gripper arm and the gripper finger, one end of the elastic member being connected with the gripper arm, and the other end of the elastic member being abutted against the gripper finger.

6. The gripper according to claim 5, comprising at least two said elastic members which are uniformly distributed on the gripper arm;
wherein the elastic member is a spring.

7. The gripper according to claim 4, wherein:
the first connecting part is connected to the gripper arm by a step screw so that the first connecting part is rotatable relative to the gripper arm with the step screw as a rotating fulcrum.

8. The gripper according to claim 7, further comprising:
a lubricating gasket arranged between the gripper arm and the gripper finger.

9. The gripper according to claim 8, wherein the step screw is arranged at a middle position of the first connecting part; and
the lubricating gasket is fixed between the gripper arm and the first connecting part by the step screw.

10. The gripper according to claim 4, wherein:
a maximum angle range of the rotation of the first connecting part relative to the gripper arm is 1 to 2 degrees; and
the first connecting part is perpendicular to the second connecting part.

11. The gripper according to claim 1, wherein the gripper arm comprises:
a third connecting part, a first end of the third connecting part being used to be connected with the driving mechanism; and
a fourth connecting part, a first end of the fourth connecting part being connected with a second end of the third connecting part, a second end of the fourth connecting part being a free end, and the gripper finger being connected to the fourth connecting part.

12. The gripper according to claim 11, wherein the second end of the fourth connecting part is flush with a forwardmost end of the gripper finger; or
the second end of the fourth connecting part extends beyond a foremost end of the gripper finger.

13. A clamping device, comprising:
a driving mechanism; and
two grippers according to claim 1, the gripper arms of the two grippers being connected with the driving mechanism respectively, the clamping surfaces of the gripper fingers of the two grippers being arranged opposite each other, and the two gripper fingers being driven by the driving mechanism to move close to or away from each other.

14. The clamping device according to claim 13, wherein:
the driving mechanism is provided with two connecting members which are slidable relative to each other, the two gripper arms are connected with the two connecting members respectively; and
a relative sliding direction of the two connecting members is the same as a relative moving direction of the two gripper fingers.

15. The clamping device according to claim 13, further comprising:
a quick-change connector which is connected with the driving mechanism and used for a quick change of a connection between the driving mechanism and a peripheral device.

16. The clamping device according to claim 14, wherein the connection between the connecting member and the gripper arm is a rotatable connection; and
the gripper finger extends in a direction perpendicular to or parallel to an orientation of the driving mechanism.

17. A mobile robot, comprising a moving mechanism and a clamping device according to claim 13, wherein the moving mechanism is connected with the clamping device and is capable of driving the clamping device to move.

18. The clamping device according to claim 4, comprising two elastic members, wherein the elastic member is arranged between the gripper arm and the gripper finger, one end of the elastic member being connected with the gripper arm, and the other end of the elastic member being abutted against the gripper finger, and the two elastic members are symmetrically arranged with the center of the second connecting part or the clamping surface as the symmetrical center.

19. The clamping device according to claim 4, comprising three elastic members, wherein the elastic member is arranged between the gripper arm and the gripper finger, one end of the elastic member being connected with the gripper arm, and the other end of the elastic member being abutted against the gripper finger; wherein one of the three elastic members is located at the center of the second connecting part or the gripping surface and the other two are symmetrically arranged with the center as the symmetrical center, or two of the three elastic members are located at the same side of the center and the other is located at the other side of the center.

20. The clamping device according to claim 4, comprising four elastic members, wherein the elastic member is arranged between the gripper arm and the gripper finger, one end of the elastic member being connected with the gripper arm, and the other end of the elastic member being abutted against the gripper finger, the four elastic members are evenly distributed along a length direction of the second connecting part or the clamping surface, or the four elastic members are arranged as two pairs which are symmetrically arranged with the center of the second connecting part or the clamping surface as the symmetrical center.
